(19) United States
(12) Patent Application Publication
(10) Pub. No.: US 2013/0087443 A1
(43) Pub. Date: Apr. 11, 2013

(54) SWITCH

(71) Applicant: Hidetake Kikuchi, Tokyo (JP)

(72) Inventor: Hidetake Kikuchi, Tokyo (JP)

(21) Appl. No.: 13/644,123

(22) Filed: Oct. 3, 2012

(30) Foreign Application Priority Data
Oct. 5, 2011 (JP) 2011-221059
Sep. 19, 2012 (JP) 2012-205686

(51) Int. Cl. H01H 13/14

(52) U.S. Cl. 200/520

(57) ABSTRACT

A switch includes a case including a recess, a plurality of fixed electrodes provided in the recess, a movable electrode provided in the recess, a pressing member and a buffer member. The case is mounted on a circuit board. The movable electrode is displaced between a first position where the plurality of fixed electrodes are electrically connected each other and a second position where the plurality of fixed electrodes are not electrically connected each other. The pressing member covers at least a portion of the recess, and displaces the movable electrode from the second position to the first position by a pressing force applied from outside. The buffer member is interposed between the movable electrode and the pressing member, and is elastically deformed by the pressing force.

### BACKGROUND

The present invention relates to a switch used in a variety of compact electronic devices and, more particularly, a push switch mounted on a circuit board.

In the device of this type, a recess is formed in a case mounted on a circuit board, and a plurality of fixed electrodes and a movable electrode are placed in the recess. The movable electrode is capable of effecting elastic displacement between a first position where the electrode holds the plurality of fixed electrodes in an electrically conductive state and a second position where the electrode holds the fixed electrodes in an electrically non-conductive state. In normal state, a pressing member is placed so as to oppose the movable electrodes in the second position. When the pressing member displaces the movable electrodes to the first position under external pressing force, the fixed electrodes are mutually brought into an electrically conductive state. When the pressing force is released, the movable electrode elastically returns to the second position, whereupon the fixed electrodes are brought into a nonconductive state (see; for instance, Patent Document 1).

An article formed by bonding a push element to a flexible film-like member is used as the pressing member. The push element is formed from a thermoplastic resin or a photo-curable resin and exhibits high rigidity. The push element is configured so as to come into contact with the movable electrode by dint of the external pressing force, thereby displacing or deforming the movable electrode (see; for instance, Patent Document 2).
[Patent Document 1] JP-A-2010-129383
[Patent Document 2] JP-A-2010-118200

### SUMMARY

According to one aspect of the present invention, there is provided a switch comprising:

a case, mounted on a circuit board, and including a recess;

a plurality of fixed electrodes provided in the recess;

a movable electrode, provided in the recess, and configured to be displaced between a first position where the plurality of fixed electrodes are electrically connected each other and a second position where the plurality of fixed electrodes are not electrically connected each other;

a pressing member, covering at least a portion of the recess, and configured to displace the movable electrode from the second position to the first position by a pressing force applied from outside; and

a buffer member, interposed between the movable electrode and the pressing member, and configured to be elastically deformed by the pressing force.

The buffer member may be made from a material containing one of silicon rubber, fluorine-based rubber, and a UV resin.

The pressing member may include a first portion covering whole of the movable electrode and a second portion projecting from the first portion along a direction in which the movable electrode is displaced, and the first portion and the second portion may be integrated.

The buffer member may include a first portion covering whole of the movable electrode and a second portion projecting from the first portion along a direction in which the movable electrode is displaced.

The pressing member may have rigidity higher than rigidity of the buffer member.

The pressing member may be made from a material containing one of polyimide, a PEEK resin, and a fluorine-based resin.

The movable electrode may have resiliency.

### BRIEF DESCRIPTION OF DRAWINGS

FIG. 1 is a perspective view showing appearance of a push switch of an embodiment of the invention.

FIGS. 2A to 2D are four orthogonal views showing the appearance of the push switch shown in FIG. 1. FIG. 2A is a top view, FIG. 2B is a front view, FIG. 2C is a bottom view, and FIG. 2D is a right side view.

FIG. 3 is an exploded perspective view of the push switch shown in FIG. 1.

FIGS. 4A and 4B are views that show a cross section of the push switch taken along line IV-IV shown in FIG. 2A and that provide explanations about deformation of individual parts of the push switch occurred when external pressing force is exerted on the push switch.

FIGS. 5A and 5B are cross sectional views showing an exemplary modification of the push switch shown in FIG. 1.

FIGS. 6A and 6B are cross sectional views showing another exemplary modification of the push switch shown in FIG. 1.

### DETAILED DESCRIPTION OF EXEMPLIFIED EMBODIMENTS

Along with recent miniaturization of electronic devices, miniaturization of constituent components of a switch itself has also been desired. As miniaturization of a movable electrode proceeds in response to the demand, load on the movable electrode stemming from contact of the movable electrode with a push element that exhibits high rigidity relatively increases. As a consequence, the movable electrode is elastically deformed, to thus become unable to perform proper elastic restoration. Since the push element with high rigidity becomes impossible to follow the elastic deformation of the movable electrode, local concentration of load develops. Therefore, there is a potential of breaking of the push element and delamination of an adhesive as well as plastic deformation of the movable electrode.

Moreover, when the switch is subjected to unexpected physical impact, the push element with high rigidity collides with the movable electrode, which may cause plastic deformation of the movable electrode or breaking of the push element. As a consequence, the switch becomes incapable of maintaining its originally-expected function.

It is therefore one advantageous aspect of the present invention to provide a switch that enables extension of life and enhancement of shock resistance by reducing load on a movable electrode while satisfying a demand for miniaturization.

By reference to the accompanying drawings, an embodiment of the invention is hereunder described in detail. Throughout the drawings hereunder used for explanation, scale sizes are changed as required in order to make individual members discernible.

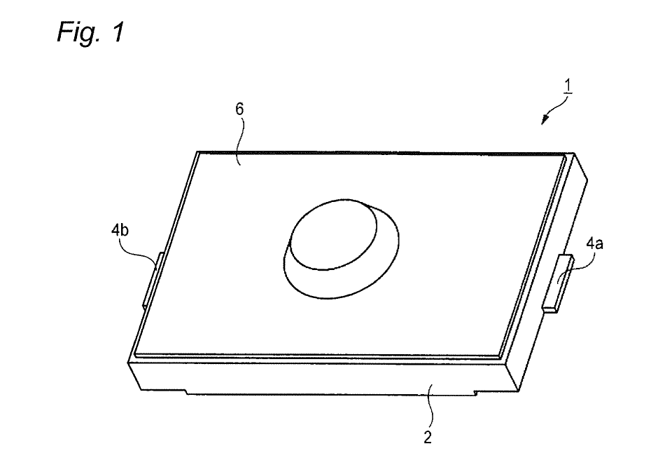

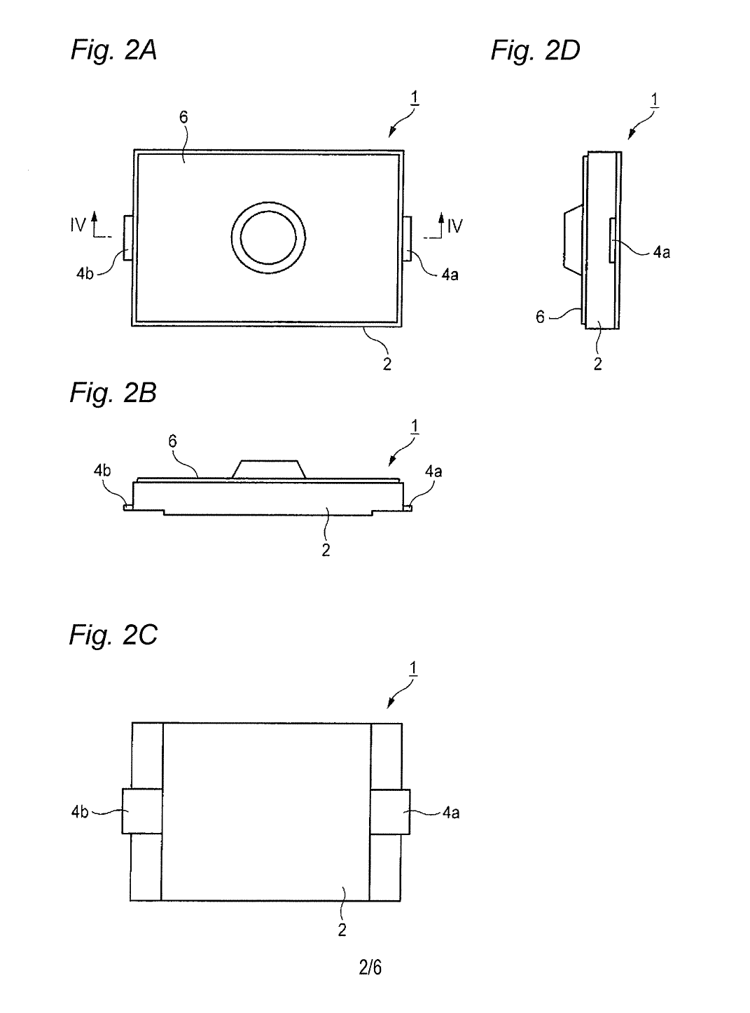

A perspective view of a push switch 1 is shown in FIG. 1 as an embodiment of the switch of the invention, and four orthogonal views of the push switch 1 are provided in FIGS. 2A to 2D. FIG. 2A is a top view; FIG. 2B is a front view; FIG. 2C is a bottom view; and FIG. 2D is a right side view. Since a rear view and a left side view of the push switch are symmetrical to the front view and the right side view, respectively, their illustrations are omitted here.

As illustrated in these drawings, the push switch 1 assumes an appearance in which a pressing member 6 is put on an upper surface of a case 2 that is mounted on a circuit boar and that is formed from an insulating resin.

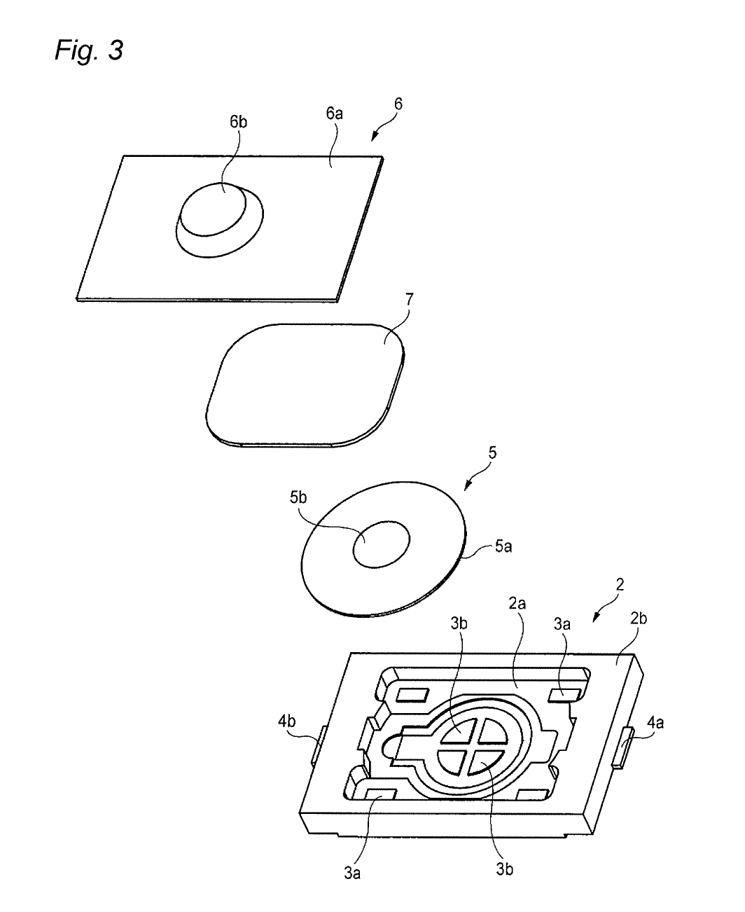

As illustrated in the exploded perspective view shown in FIG. 3, the case 2 has an upper surface 2b with an open recess 2a. A plurality of first fixed electrodes 3a are disposed at four corners of a bottom of the recess 2a. Further, a plurality of second fixed electrodes 3b are also disposed at a center of the bottom. The first fixed electrodes 3a and the second fixed electrodes 3b perform as a plurality of fixed electrodes of the invention.

The first fixed electrodes 3a remain in electrical conduction with a first external connection terminal 4a in the individual case 2. Further, the second fixed electrodes 3b remain in electrical conduction with a second external connection terminal 4b in the individual case 2. The first external connection terminal 4a and the second external connection terminal 4b are soldered to lands of wiring terminals formed on a mount surface of an individual circuit board.

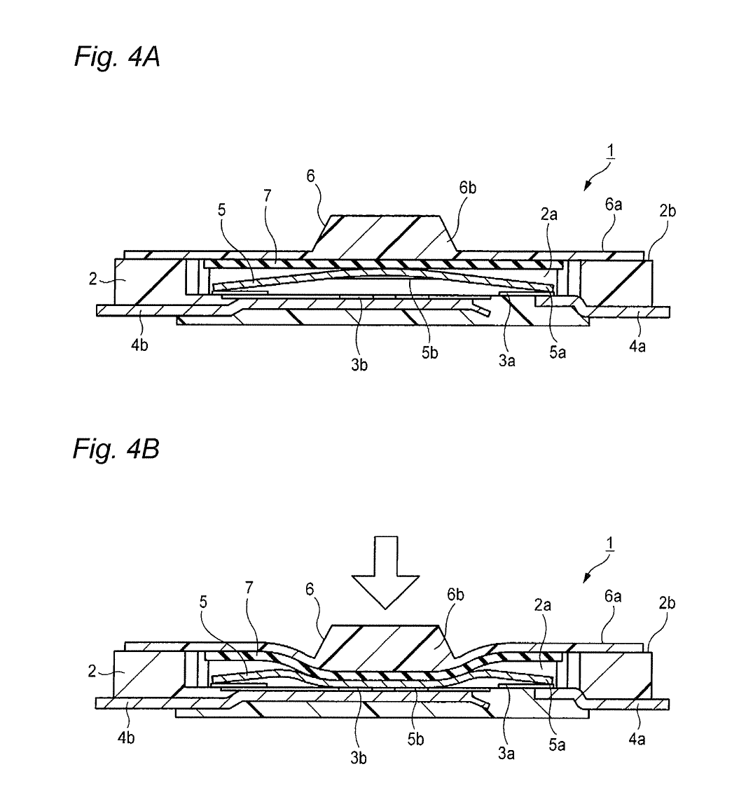

The movable electrode 5 is housed in the recess 2a of the case 2. The movable electrode 5 is a dome-shaped conductive member capable of elastic deformation. As can be seen in a cross section shown in FIG. 4A, the movable electrode 5 is placed in the recess 2a in such a way that an outer edge 5a contacts the first fixed electrodes 3a and that a center portion 5b opposes while spaced away from the second fixed electrodes 3b. Specifically, the movable electrode 5 remains convexed upwardly in normal times.

The pressing member 6 is placed on the upper surface 2b (see FIG. 3) of the case 2 so as to cover the recess 2a and undergoes pressing operation from above (outside) by means of operation of an unillustrated button, and the like.

A buffer member 7 is interposed between the movable electrode 5 and the pressing member 6. The buffer member 7 is formed from a material containing any one of silicon rubber, fluorine-based rubber, and a UV resin and exhibits elasticity and high flexibility. Specifically, the buffer member 7 exhibits an elastic coefficient that is higher than that of the pressing member 6. Since the material exhibits heat resistance, the material is useful for a case where reflow treatment is used for soldering performed when the push switch 1 is mounted on a circuit board.

The center portion 5b of the movable electrode 5 situated at a lower position is pressed under pressing force stemming from operation of an unillustrated button, or the like, by way of the pressing member 6 and the buffer member 7. When the load exerted on the movable electrode 5 exceeds a predetermined value, the center portion 5b is inverted with tactile feedback, to thus become convexed downwardly at the lower position and contact the second fixed electrodes 3b.

Along with the inverting action, the first fixed electrodes 3a and the second fixed electrodes 3b are brought into electrical conduction by way of the movable electrode 5. When released from the pressing force, the center portion 5b restores its original state (i.e., an upwardly convexed state) along with the tactile feedback under self-restoration force (elasticity) of the movable electrode 5, whereupon the first fixed electrodes 3a and the second fixed electrodes 3b are released from the electrically conductive state. Consequently, the essential requirement is to provide at least one first fixed electrode 3a and at least one second fixed electrode 3b.

More specifically, the movable electrode 5 is capable of displacement between a first position where a plurality of fixed electrodes are electrically connected each other and a second position where the fixed electrodes are not electrically connected each other. The pressing member 6 displaces the movable electrode 5 from the second position to the first position under external pressing force.

The pressing member 6 has a flat portion 6a (a first portion) and a raised portion 6b (a second portion). The flat portion 6a expands so as to cover the entire movable electrode 5, to thus reach the upper surface 2b of the case 2. In other words, at least a portion of the upper surface 2b of the case 2 is covered with the flat portion 6a of the pressing member 6. The raised portion 6b assumes the shape of a circular truncated cone and projects upward at the center of the flat portion 6a. In other words, a direction of projection of the raised portion 6b is in line with a direction of displacement of the movable electrode 5.

The flat portion 6a and the raised portion 6b are formed to an integral structure. The “integral structure” designates a state in which a boundary between the flat portion 6a and the raised portion 6b is formed from the same material in a continuous manner. The term is used in distinction from another structure in which two or more members of different materials or characteristics are integrated by means of bonding or welding. In other words, the integral structure designates a monolithic state.

The pressing member 6 is formed from polyimide, a PEEK (polyether ether ketone) resin, or a material containing a thermoplastic resin, such as a fluorine-based resin, or a thermosetting resin. Since the materials exhibit heat resistance, they are useful in a case where reflow treatment is used for soldering performed when the push switch 1 is mounted on a circuit board.

The buffer member 7 is bonded to a lower surface of the flat portion 6a of the pressing member 6; namely, a side of the pressing member facing the movable electrode 5, by means of an appropriate adhesive. The buffer member 7 is configured so as to be capable of elastic deformation while following deformation of the pressing member 6 by the pressing operation.

By reference to FIGS. 4A and 4B, there are described in detail operation of individual portions performed when the push switch 1 is activated.

FIG. 4A shows a normal state; namely, a state in which pressing force caused by an unillustrated operation member, such as a button, is not exerted on the push switch. As mentioned above, the movable electrode 5 is housed in the recess of the case 2 while being convexed upwardly, and the center portion 5b of the movable electrode 5 and the second fixed electrodes 3b remain out of contact with each other. Therefore, the first fixed electrodes 3a and the second fixed electrodes 3b (the first external connection terminal 4a and the second external connection terminal 4b) are in a non-conductive state.

When pressing force is exerted on the pressing member 6 from the outside as designated by an arrow shown in FIG. 4B, the flat portion 6a of the pressing member 6 that exhibits relatively low rigidity is deformed, whereupon the raised portion 6b goes down while maintaining its original shape. The raised portion 6b enters the recess 2a of the case 2, to thus perform as a push element and press the movable electrode 5 downwards by way of the buffer member 7.

Since the movable electrode 5 attempts to sustain its convex state in the upward direction, load exerted on the movable electrode 5 and the buffer member 7 gradually increases. Consequently, the buffer member 7 becomes elastically deformed so as to be collapsed.

When the load exerted on the movable electrode 5 exceeds a predetermined value, the center portion 5b is inverted with tactile feedback, to thus become convex in the downward direction. The center portion 5b and the second fixed electrodes 3b thereby contact each other (the movable electrode 5 is displaced to the first position), the first fixed electrodes 3a and the second fixed electrodes 3b (the first external connection terminal 4a and the second external connection terminal 4b) enter electrical conduction by way of the movable electrode 5.

When the pressing force is continually exerted on the pressing member 6 even after the movable electrode 5 and the second fixed electrodes 3b have contacted each other (the movable electrode 5 has been displaced to the first position), the movable electrode 5 cannot be deformed any further. Hence, the load exerted on the movable electrode 5 and the buffer member 7 again increases. However, the buffer member 7 becomes elastically deformed so as to be further collapsed, thereby preventing exertion of excessive load on the movable electrode 5.

When the force of pressing operation is canceled, the center portion 5b restores its upwardly convexed state (is displaced to the second position) along with tactile feedback by means of self-restoration force (elasticity) of the movable electrode 5, thereby releasing the first fixed electrodes 3a and the second fixed electrodes 3b from the state of electrical conduction. Further, as a result of the pressing member 6 being pushed back upward by means of self-restoration force (elasticity) of the buffer member 7, the pressing member returns to its initial state shown in FIG. 4A.

In the switch of the embodiment having the foregoing configuration, the buffer member 7 is elastically deformed by the pressing force applied from the outside. Hence, local concentration of load on the movable electrode 5 can be avoided. Consequently, plastic deformation of the movable electrode 5 can be prevented with use of the pressing member 6 that has hitherto been used and that exhibits comparatively high rigidity. Therefore, the life of the push switch 1 can be extended while the request for miniaturization of the push switch is satisfied.

Since the buffer member 7 becomes elastically deformed while following elastic deformation of the movable electrode 5, the buffer member 7 can absorb physical impact developed at elastic deformation of the movable electrode 5. For this reason, it is possible to prevent plastic deformation of the movable electrode 5, which would otherwise be caused by local concentration of load, but also breaking of the pressing member, which would otherwise arise as a result of transmission of the impact to the pressing member 6. Consequently, the life of the push switch 1 can be extended while the request for miniaturization is satisfied.

Even when external pressing force is continually applied to the movable electrode 5 even after the movable electrode 5 has contacted the second fixed electrodes 3b (displaced to the first position), excessive load exerted on the movable electrode 5 can be absorbed by means of elastic deformation of the buffer member 7. Therefore, plastic deformation of the movable electrode 5, which would otherwise be caused by continual application of excessive load on the movable electrode 5 after elastic deformation of the movable electrode 5, can be prevented, and the pressing member 6 is not broken by such excessive load. Therefore, the life of the push switch 1 can be extended while the request for miniaturization of the push switch is satisfied.

The pressing member 6 having the raised portion 6b that works as a push element as described in connection with the embodiment has been known to be likely to locally exert pressing force to the movable electrode 5 and hence more useful as the push switch 1 is smaller. In the meantime, the locally applied load may cause plastic deformation of the movable electrode 5 and breaking of the pressing member 6. However, as described in connection with the embodiment, the buffer member 7 disperses load and absorbs physical impact, thereby preventing occurrence of such a problem while the request for miniaturization is satisfied.

Even when the pressing member 6 has been displaced by unexpected physical impact, the physical impact can be absorbed by means of elastic deformation of the buffer member 7. In addition, the pressing member 6 is caused to return to its original position by means of the self-restoration force (elasticity) of the buffer member 7, thereby making it possible to maintain a state in which the original function of the push switch 1 can be exhibited. Therefore, impact resistance of the push switch 1 can be enhanced while the request for miniaturization is satisfied.

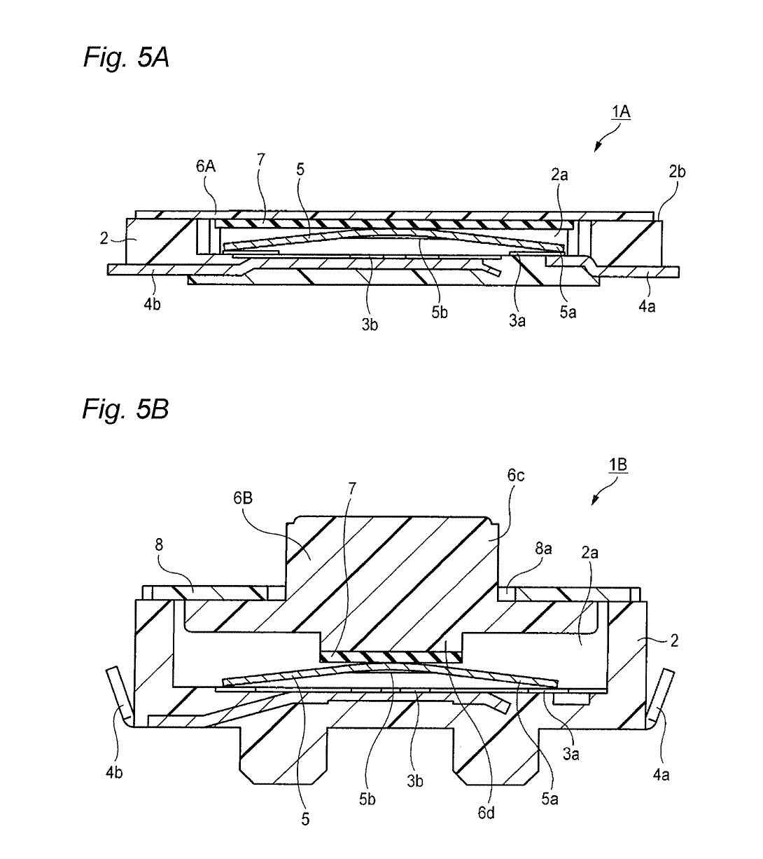

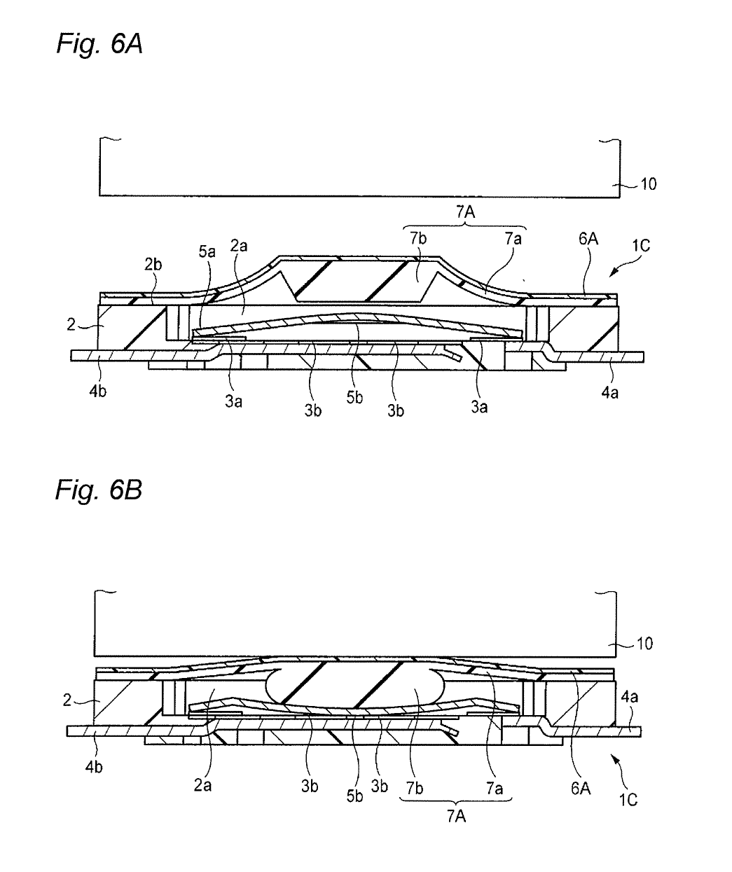

An exemplary modification of the embodiment is now described by reference to FIGS. 5A and 5B and FIGS. 6A and 6B. Elements that exhibit substantially the functions identical with or equivalent to those exhibited by the embodiment are assigned the same reference numerals, and their repeated explanations are omitted. Cross sections shown in FIGS. 5A, 5B, 6A, and 6B correspond to cross sections taken along line IV-IV shown in FIG. 2A as in the case of FIGS. 4A and 4B.

A push switch 1A shown in FIG. 5A differs from the pressing member 6 of the embodiment in that a pressing member 6A is not equipped with the raised portion 6b. The buffer member 7 is bonded to a lower surface of the pressing member 6A; namely, a side of the pressing member 6A facing the movable electrode 5, by means of an appropriate adhesive and is made capable of elastic deformation while following deformation of the pressing member 6A caused by pressing operation.

A push switch 1B shown in FIG. 5B differs from the pressing member 6 of the embodiment in that a pressing member 6B is configured as a button member equipped with an upper raised portion 6c and a lower raised portion 6d.

The recess 2a of the case 2 is covered with a cover member 8 having an opening 8a, and the upper raised portion 6c of the pressing member 6B projects upwardly by way of the opening 8a. A portion of the pressing member 6B including the lower raised portion 6d is housed in the recess 2a and held slidable in the vertical direction.

The pressing member 6B is formed from polyimide, a PEEK (polyether ether ketone) resin, or a material containing a thermoplastic resin, such as a fluorine-based resin, or a thermosetting resin, and exhibits rigidity which is higher than that exhibited by the buffer member 7. The pressing member 6B is also formed such that the entirety of the pressing member, including the upper raised portion 6c and the lower raised portion 6d, provides an integral structure.

The buffer member 7 is bonded to a lower surface of the lower raised portion 6d of the pressing member 6B; namely, a side of the pressing member facing the movable electrode 5, by means of an appropriate adhesive. When the pressing member 6B is subjected to downward pressing operation (button operation), the buffer member 7 is pressed against the movable electrode 5, to thus become elastically deformed.

A push switch 10 shown in FIG. 6A differs from the buffer member 7 of the push switch 1A in that a buffer member 7A is equipped with a support portion 7a and a raised portion 7b.

The support portion 7a serving as a first portion of the buffer member 7A extends so as to cover the entirety of the movable electrode 5, reaching the upper surface 2b of the case 2. In other words, at least a portion of the upper surface 2b of the case 2 is covered with the support portion 7a of the buffer member 7A.

The raised portion 7b serving as a second portion of the buffer member 7A is supported so as to project downwardly at a center of the support portion 7a. Specifically, the direction of projection of the raised portion 7b is in line with the direction of displacement of the movable electrode 5.

The support portion 7a and the raised portion 7b are formed from a material containing; for instance, any of silicon rubber, fluorine-based rubber, and a UV resin, and exhibit elasticity and high flexibility. Specifically, the buffer member 7A exhibits an elastic coefficient that is higher than that of the pressing member 6A. Moreover, the support portion 7a and the raised portion 7b are formed to an integral structure.

FIG. 6A shows a normal state; namely, a state in which pressing force caused by an operation member 10, such as a button, is not exerted on the push switch. The raised portion 7b of the buffer member 7A projects downwards while remaining intact, opposing the movable electrode 5. The movable electrode 5 is housed in the recess of the case 2 while convexed upwardly, and the center portion 5b of the movable electrode 5 and the second fixed electrodes 3b remain out of contact with each other. Therefore, the first fixed electrodes 3a and the second fixed electrodes 3b (the first external connection terminal 4a and the second external connection terminal 4b) remain in a non-conductive state.

When pressing force is applied from the outside such that the operation member 10 is downwardly displaced, the raised portion 7b of the buffer member 7A enters the recess 2a of the case 2 as shown in FIG. 6B, to thus contact the movable electrode 5. The raised portion 7b presses the movable electrode 5 downwardly while undergoing elastic deformation so as to be collapsed with downward displacement of the operation member 10. Specifically, the raised portion 7b performs as a so-called push element.

Since the movable electrode 5 attempts to maintain the upwardly raised state, the load exerted on the movable electrode 5 and the buffer member 7A gradually increases. Therefore, the raised portion 7b is elastically deformed so as to be further collapsed, so that a contact area between the movable electrode 5 and the pressing member 7A gradually increases.

When the load exerted on the movable electrode 5 exceeds a predetermined value, the center portion 5b is inverted with tactile feedback, to thus become downwardly convexed. The center portion 5b and the second fixed electrodes 3b thereby contact each other (the movable electrode 5 is displaced to the first position), whereupon the first fixed electrodes 3a and the second fixed electrodes 3b (the first external connection terminal 4a and the second external connection terminal 4b) enter a state of electrical conduction by way of the movable electrode 5. A portion of the load imposed by the operation member 10 is released by means of deformation of the movable electrode 5.

When pressing force is continually exerted on the operation member 10 even after the movable electrode 5 has contacted the second fixed electrodes 3b (has been displaced to the first position), the movable electrode 5 cannot be deformed any further. Therefore, the load exerted on the movable electrode 5 and the buffer member 7A again increases. The raised portion 7b is elastically deformed so as to be collapsed further, and an increase gradually occurs in the volume of an area where the buffer member 7A is situated in the recess 2a of the case 2.

The operation member 10 is downwardly displaced by further elastic deformation of the buffer member 7A, and a portion of the operation member 10 contacts the pressing member 6A in due course. The operation member 10 is supported by the upper surface 2b of the case 2 by way of the pressing member 6A. A dimension of the raised portion 7b and a dimension of the recess 2a are determined such that the entirety of the raised portion 7b that is elastically deformed in this state can be accommodated in the recess 2a of the case 2.

Even if the pressing force is continually exerted further on the operation member 10 in this state, the load will be received by the upper surface 2b of the case 2, so that the movable electrode 5 and the buffer member 7A are prevented from undergoing any further load.

When the pressing force on the operation member 10 is canceled, the center portion 5b restores the upwardly-convexed state at an upper position along with tactile feedback under the self-restoration force (elasticity) of the movable electrode 5 (the movable electrode is displaced to the second position), thereby releasing the first fixed electrodes 3a and the second fixed electrodes 3b from the state of electrical conduction. Moreover, the operation member 10 is pushed back upward by means of the self-restoration force (elasticity) of the buffer member 7A, reaching an initial state shown in FIG. 6A.

The configuration described in connection with the embodiment yields the same advantage as that described in connection with the switch 1 of the embodiment. The raised portion 7b of the buffer member 7A opposes the movable electrode 5 at a position below the pressing member 6A and remains unexposed on an exterior surface of the switch 1C. For these reasons, there can be avoided damage to the raised portion 7b, which would otherwise be inflicted by interference of the raised portion 7b with another member, or the like. Hence, deterioration of feeling of switching operation can be prevented.

Although only some exemplary embodiments of the invention have been described in detail above, those skilled in the art will readily appreciated that many modifications are possible in the exemplary embodiments without materially departing from the novel teachings and advantages of the invention. Accordingly, all such modifications are intended to be included within the scope of the invention.

Expressions “upward” and “downward” used in the descriptions are merely used for the sake of convenience of explanation provided by reference to the drawings and are not intended to pose restrictions on a direction in which a product is used. The expressions “upward” and “downward” can therefore be translated into expressions, like a “direction of an increasing distance from a circuit board” and a “direction of an approach to a circuit board.”

The support portion 7a and the raised portion 7b of the buffer member 7A do not necessarily be formed so as to form an integral structure. As long as desired elastic deformation is achieved, the buffer member 7A can also be formed by bonding or welding together the support portion 7a and the raised portion 7b that are formed as separate members.

The pressing member 6 (6A, 6B) and the buffer member 7 (7A) do not always need to be formed as independent members formed from different materials. So long as the members are capable of desired elastic deformation, the pressing member 6 (6A, 6B) and the buffer member 7 (7A) can also be formed integrally from an appropriately-selected signal material.

The shape and number of the raised portion 6b of the pressing member 6 are not limited to those described in connection with the embodiment. They can be determined as appropriate in accordance with specifications of the push switch 1 and the operation member 10.

The movable electrode 5 can adopt an appropriate shape and configuration, so long as it can be displaced by the pressing member 6 from a position where a plurality of fixed electrodes can be brought into a non-conductive state to another position where the fixed electrodes are brought into a state of electrical conduction. The movable electrode 5 does not always need to assume elasticity.

In the above configuration, the buffer member becomes elastically deformed while following displacement of the movable electrode caused by the pressing force. Hence, local concentration of load between the movable electrode and the pressing member can be avoided.

According to the present invention, the second portion can be effectively utilized as a push element, thereby enabling avoidance of separation of the first portion from the second portion, which would otherwise be caused by an impact.

In the invention, the buffer member can perform as a push element. Moreover, the projecting second portion remains unexposed outside the switch, thereby avoiding infliction of damage to the second portion, which would otherwise be caused when interfering with another member, or the like. Therefore, deterioration of feeling of switching operation can be prevented.

The invention enables avoidance of local concentration of load between the movable electrode and the pressing member; hence, makes it possible to accomplish extension of life by reducing load on the movable electrode while meeting a request for the miniaturization of a switch.

What is claimed is:

1. A switch comprising:
a case, mounted on a circuit board, and including a recess;
a plurality of fixed electrodes provided in the recess;
a movable electrode, provided in the recess, and configured to be displaced between a first position where the plurality of fixed electrodes are electrically connected each other and a second position where the plurality of fixed electrodes are not electrically connected each other;
a pressing member, covering at least a portion of the recess, and configured to displace the movable electrode from the second position to the first position by a pressing force applied from outside; and
a buffer member, interposed between the movable electrode and the pressing member, and configured to be elastically deformed by the pressing force.

2. The switch according to claim 1, wherein
the buffer member is made from a material containing one of silicon rubber, fluorine-based rubber, and a UV resin.

3. The switch according to claim 1, wherein
the pressing member includes a first portion covering whole of the movable electrode and a second portion projecting from the first portion along a direction in which the movable electrode is displaced; and
the first portion and the second portion are integrated.

4. The switch according to claim 1, wherein
the buffer member includes a first portion covering whole of the movable electrode and a second portion projecting from the first portion along a direction in which the movable electrode is displaced.

5. The switch according to claim 1, wherein
the pressing member has rigidity higher than rigidity of the buffer member.

6. The switch according to claim 1, wherein
the pressing member is made from a material containing one of polyimide, a PEEK resin, and a fluorine-based resin.

7. The switch according to claim 1, wherein
the movable electrode has resiliency.
